(19) United States
(12) Patent Application Publication
(10) Pub. No.: US 2025/0226868 A1
(43) Pub. Date: Jul. 10, 2025

(54) METHOD AND APPARATUS FOR CHANNEL STATE INFORMATION REPORTING IN WIRELESS COMMUNICATION SYSTEM

(71) Applicant: Samsung Electronics Co., Ltd., Suwon-si (KR)

(72) Inventors: Jingxing FU, Beijing (CN); Feifei SUN, Beijing (CN); Zhe CHEN, Beijing (CN)

(21) Appl. No.: 18/965,451

(22) Filed: Dec. 2, 2024

(30) Foreign Application Priority Data
Jan. 8, 2024 (CN) 202410030772.3

(51) Int. Cl. H04B 7/06; H04L 5/14; H04W 72/0446

(52) U.S. Cl. CPC H04B 7/0626; H04L 5/14; H04W 72/0446

(57) ABSTRACT

A method performed by a user equipment (UE) in a wireless communication system is provided. The method includes receiving, from a base station (BS), first configuration information indicating a resource for channel state information (CSI) reporting and second configuration information indicating a subband full duplex (SBFD) symbol in downlink symbols or flexible symbols, determining a valid downlink slot for CSI measurement based on the first configuration information and the second configuration information, determining CSI based on the determined valid downlink slot, and transmitting, to the BS, the determined CSI.

### CROSS-REFERENCE TO RELATED APPLICATION(S)

This application is based on and claims priority under 35 U.S.C. § 119(a) of a Chinese patent application number 202410030772.3, filed on Jan. 8, 2024, in the Chinese National Intellectual Property Administration, the disclosure of which is incorporated by reference herein in its entirety.

### BACKGROUND

### 1. Field

The disclosure relates to wireless communication networks. More particularly, the disclosure relates to a method and apparatus for channel state information (CSI) reporting in a wireless communication system.

### 2. Description of Related Art

Generally, 5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement 6^{th} generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input-multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on the UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of the UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for channel state information (CSI) reporting in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station (BS), first configuration information indicating a resource for channel state information (CSI) reporting and second configuration information indicating a subband full duplex (SBFD) symbol among downlink symbols or flexible symbols, determining a valid downlink slot for CSI measurement based on the first configuration information and the second configuration information, determining CSI based on the determined valid downlink slot, and transmitting, to the BS, the determined CSI.

In accordance with an aspect of the method performed by the UE described above, for example, determining a valid downlink slot for CSI measurement based on the first configuration information and the second configuration information includes determining a valid downlink slot based on a slot n-n_{CSI_ref}, wherein n is an index of an uplink slot for transmitting the CSI determined based on the first configuration information, wherein n_{CSI_ref} is determined based on the first configuration information and the second configuration information, and wherein n_{CSI_ref} is a smallest value greater than or equal to a parameter related to delay requirement, such that the slot n-n_{CSI_ref} is a valid downlink slot.

In accordance with an aspect of the method performed by the UE described above, for example, determining CSI based on the determined valid downlink slot includes measuring a reference signal in slot n-n_{CSI_ref} to obtain the CSI.

In accordance with an aspect of the method performed by the UE described above, for example, a slot including at least one downlink symbol or flexible symbol and not included in a measurement gap for the UE is determined as the valid downlink slot.

In accordance with an aspect of the method performed by the UE described above, for example, a slot including at least one SBFD symbol is determined as the valid downlink slot, wherein an active downlink BWP is not completely included within an uplink band and/or guard band in the SBFD symbol, or a slot including at least one SBFD symbol and not included in a measurement gap for the UE is determined as the valid downlink slot, wherein an active downlink BWP is not completely included within an uplink band and/or guard band in the SBFD symbol.

In accordance with an aspect of the method performed by the UE described above, for example, a slot including at least one SBFD symbol is determined as the valid downlink slot, wherein a proportion of an uplink band and/or a guard band in the SBFD symbol included in an active downlink BWP is less than or equal to a first threshold value, or a slot including at least one SBFD symbol and not included in a measurement gap for the UE is determined as the valid downlink slot, wherein a proportion of an uplink band and/or a guard band in the SBFD symbol included in an active downlink BWP is less than or equal to the first threshold value.

In accordance with an aspect of the method performed by the UE described above, for example, the method further includes receiving third configuration information for configuring the one or more downlink symbols or the one or more flexible symbols, wherein the third configuration information includes time division duplex (TDD) uplink (UL)-downlink (DL) common configuration information and/or TDD UL-DL dedicated configuration information.

In accordance with an aspect of the method performed by the UE described above, for example, the second configuration information includes cell-common SBFD configuration information and/or UE-specific SBFD configuration information.

In accordance with another aspect of the disclosure, a method performed by a base station in a wireless communication system is provided. The method includes transmitting, to a user equipment (UE), first configuration information indicating a resource for channel state information (CSI) reporting and second configuration information indicating a subband full duplex (SBFD) symbol among downlink symbols or flexible symbols, and receive, from the UE, CSI, wherein the CSI is determined based on a valid downlink slot for CSI measurement, and wherein the valid downlink slot for CSI measurement is determined based on the first configuration information and the second configuration information.

In accordance with an aspect of the method performed by the base station described above, for example, the valid downlink slot is determined based on a slot n-n_{CSI_ref}, n is an index of an uplink slot for transmitting the CSI determined based on the first configuration information, n_{CSI_ref} is determined based on the first configuration information and the second configuration information, and n_{CSI_ref} is a smallest value greater than or equal to a parameter related to delay requirement, such that the slot n-n_{CSI_ref} is a valid downlink slot.

In accordance with an aspect of the method performed by the base station described above, for example, the CSI is obtained by measurement of a reference signal in slot n-n_{CSI_ref}.

In accordance with an aspect of the method performed by a base station described above, for example, a slot including at least one downlink symbol or flexible symbol and not included in a measurement gap for the UE is determined as the valid downlink slot.

In accordance with an aspect of the method performed by the base station described above, for example, a slot including at least one SBFD symbol is determined as the valid downlink slot, wherein an active downlink BWP is not completely included within an uplink band and/or guard band in the SBFD symbol, or a slot including at least one SBFD symbol and not included in a measurement gap for the UE is determined as the valid downlink slot, wherein an active downlink BWP is not completely included within an uplink band and/or guard band in the SBFD symbol.

In accordance with an aspect of the method performed by the base station described above, for example, a slot including at least one SBFD symbol is determined as the valid downlink slot, wherein a proportion of an uplink band and/or a guard band in the SBFD symbol included in an active downlink BWP is less than or equal to a first threshold value, or a slot including at least one SBFD symbol and not included in a measurement gap for the UE is determined as the valid downlink slot, wherein a proportion of an uplink band and/or a guard band in the SBFD symbol included in an active downlink BWP is less than or equal to the first threshold value.

In accordance with an aspect of the method performed by the base station described above, for example, the method further includes transmitting third configuration information for configuring the one or more downlink symbols or the one or more flexible symbols, wherein the third configuration information includes time division duplex (TDD) uplink (UL)-downlink (DL) common configuration information and/or TDD UL-DL dedicated configuration information.

In accordance with an aspect of the method performed by the base station described above, for example, the second configuration information includes cell-common SBFD configuration information and/or the UE specific SBFD configuration information.

In accordance with another aspect of the disclosure, a user equipment (UE) in a wireless communication system is provided. The UE includes a transceiver, and one or more processors coupled with the transceiver and configured to receive, from a base station (BS), first configuration information indicating a resource for channel state information (CSI) reporting and second configuration information indicating a subband full duplex (SBFD) symbol among downlink symbols or flexible symbols, determine a valid downlink slot for CSI measurement based on the first configuration information and the second configuration information, determine CSI based on the determined valid downlink slot, and transmit, to the BS, the determined CSI.

In accordance with another aspect of the disclosure, a base station in a wireless communication system is provided. The base station includes a transceiver, and one or more processors coupled with the transceiver and configured to transmit, to a user equipment (UE), first configuration information indicating a resource for channel state information (CSI) reporting and second configuration information indicating a subband full duplex (SBFD) symbol among downlink symbols or flexible symbols, receive, from the UE, CSI, wherein the CSI is determined based on a valid downlink slot for CSI measurement, and wherein the valid downlink slot for CSI measurement is determined based on the first configuration information and the second configuration information.

In accordance with another aspect of the disclosure, one or more non-transitory computer-readable storage media storing one or more computer programs including computer-executable instructions that, when executed by one or more processors of a user equipment (UE) in a wireless communication system individually or collectively, cause the UE to perform operations is provided. The operations include receiving, from a base station (BS), first configuration information indicating a resource for channel state information (CSI) reporting and second configuration information indicating a subband full duplex (SBFD) symbol among downlink symbols or flexible symbols, determining a valid downlink slot for CSI measurement based on the first configuration information and the second configuration information, determining CSI based on the determined valid downlink slot, and transmitting, to the BS, the determined CSI.

In accordance with another aspect of the disclosure, one or more non-transitory computer-readable storage media storing one or more computer programs including computer-executable instructions that, when executed by one or more processors of a base station individually or collectively, cause the base station to perform operations are provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a schematic diagram of an example wireless network according to an embodiment of the disclosure;

FIGS. 2A and 2B illustrate example wireless transmission and reception paths according to various embodiments of the disclosure;

FIG. 3A illustrates an example user equipment (UE) according to an embodiment of the disclosure;

FIG. 3B illustrates an example gNodeB (gNB) according to an embodiment of the disclosure;

FIG. 4 illustrates a schematic diagram of an uplink-downlink configuration according to an embodiment of the disclosure;

FIG. 5 illustrates a schematic diagram of timing of CSI reporting according to an embodiment of the disclosure;

FIG. 6 illustrates a flowchart of CSI reporting of a UE according to an embodiment of the disclosure;

FIG. 7 illustrates a diagram of a valid downlink slot according to an embodiment of the disclosure;

FIG. 8 illustrates a diagram of a valid downlink slot according to an embodiment of the disclosure;

FIG. 9 illustrates a diagram of a valid downlink slot according to an embodiment of the disclosure;

FIG. 10 illustrates a flowchart of a method performed by a terminal according to an embodiment of the disclosure;

FIG. 11 illustrates a flowchart of a method performed by a base station according to an embodiment of the disclosure;

FIG. 12 illustrates a block diagram of a configuration of a first node (e.g., a terminal) according to an embodiment of the disclosure; and

FIG. 13 illustrates a block diagram of a configuration of a second node (e.g., a base station) according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In order to meet the increasing demand for wireless data communication services since the deployment of 4G communication systems, efforts have been made to develop improved 5G or pre-5G communication systems. The 5G or pre-5G communication systems are also called “Beyond 4G networks” or “Post-long term evolution (LTE) systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift-keying (FSK) and Quadrature Amplitude Modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In order to make the purpose, technical schemes and advantages of the embodiments of the disclosure clearer, the technical schemes of the embodiments of the disclosure will be described clearly and completely with reference to the drawings of the embodiments of the disclosure. The described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. Additionally, the term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Furthermore, in the description of the example embodiments of the disclosure, “/”, when used in two parallel items, may mean “and/or”. For example, “A/B” may mean A and/or B.

Various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. The non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” may mean one or more. The set of items may be a single item or a collection of two or more items.

In the disclosure, to determine whether a specific condition is satisfied or fulfilled, expressions, such as “greater than/larger than” or “less than/smaller than” are used by way of example and expressions, such as “greater than or equal to” or “less than or equal to” are also applicable and not excluded. In an example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. Furthermore, the technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies.

The embodiments of the disclosure will be described in detail with reference to the accompanying drawings. It should be noted that the same reference numerals in different drawings will be used to refer to the same elements already described.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

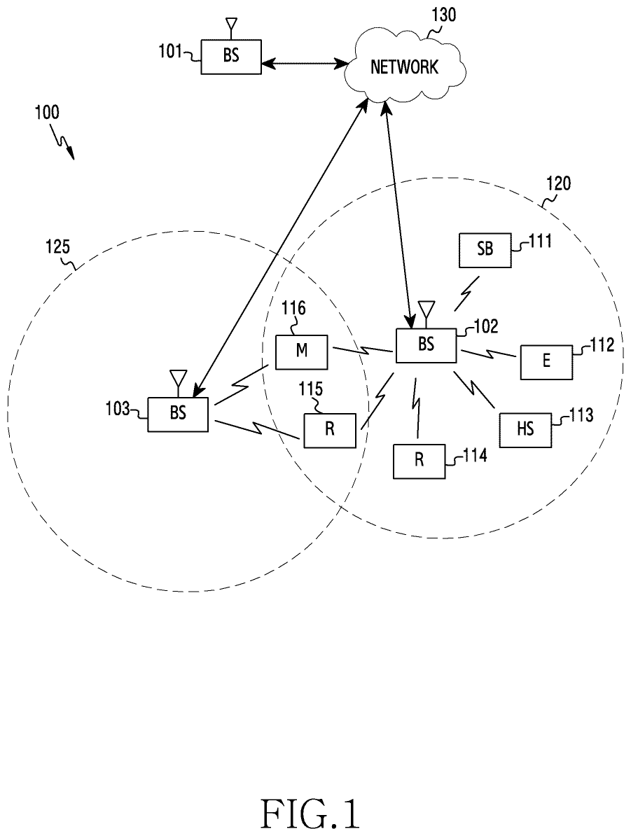

The following FIGS. 1, 2A, 2B, 3A, and 3B describe various embodiments implemented by using orthogonal frequency division multiplexing (OFDM) or orthogonal frequency division multiple access (OFDMA) communication technologies in wireless communication systems. The descriptions of FIGS. 1, 2A, 2B, 3A, and 3B do not mean physical or architectural implications for the manner in which different embodiments may be implemented. Different embodiments of the disclosure may be implemented in any suitably arranged communication systems.

FIG. 1 illustrates an example wireless network 100 according to an embodiment of the disclosure.

The embodiment of a wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. In an example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of User Equipments (UEs) within a coverage area 120 of the gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The gNB 103 provides wireless broadband access to network 130 for a second plurality of UEs within a coverage area 125 of the gNB 103. The second plurality of UEs include a UE 115 and a UE 116. In some implementations, one or more of the gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a two-dimensional (2D) antenna array as described in embodiments of the disclosure. In some implementations, one or more of the gNB 101, the gNB 102, and the gNB 103 support codebook designs and structures for systems with 2D antenna arrays.

Although FIG. 1 illustrates an example of the wireless network 100, various changes can be made to FIG. 1. The wireless network 100 can include any number of the gNBs and any number of UEs in any suitable arrangement, for example. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, the gNBs 101, 102 and/or 103 can provide access to other or additional external networks, such as external telephone networks or other types of data networks.

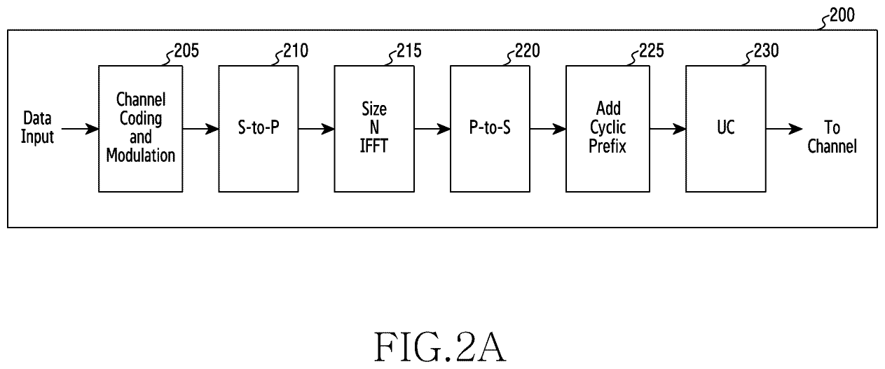

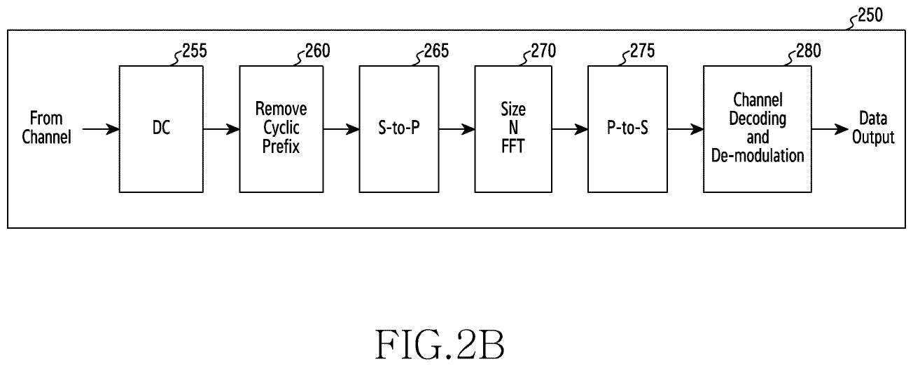

FIGS. 2A and 2B illustrate example wireless transmission and reception paths according to various embodiments of the disclosure.

In the following description, the transmission path 200 can be described as being implemented in a gNB, such as gNB 102, and the reception path 250 can be described as being implemented in a UE, such as the UE 116. It should be understood that the reception path 250 can be implemented in a gNB and the transmission path 200 can be implemented in a UE. In some implementations, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes, for example, a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts, for example, a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of the gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. FIGS. 2A and 2B are intended to illustrate examples of types of transmission and reception paths that can be used in a wireless network. Any other suitable architecture can be used to support wireless communication in a wireless network.

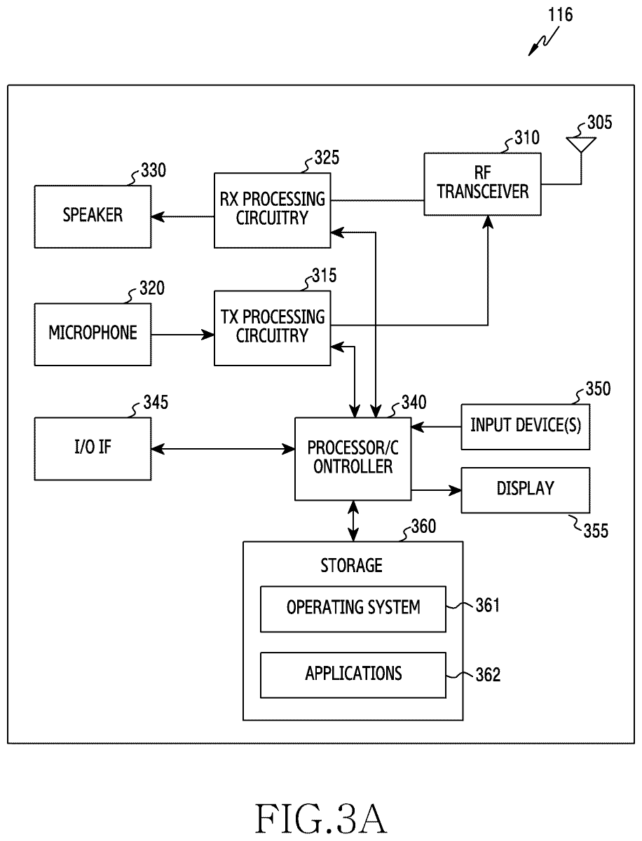

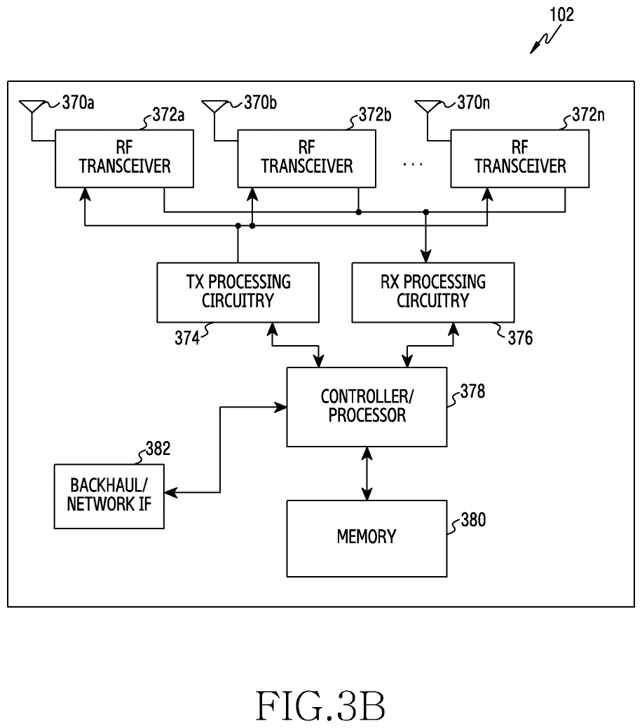

FIG. 3A illustrates an example of the UE 116 according to an embodiment of the disclosure.

The embodiment of the UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. In an embodiment, the RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. In another embodiment, the RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. In other implementations, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In various implementations, the processor/controller 340 is configured to execute the application 362 based on the OS 361 or in response to signals received from the gNB or the operator. The processor/controller 340 is also coupled to an I/O interface 345, where the I/O interface 345 provides the UE 116 with the ability to connect to other devices such as laptop computers and handheld computers. I/O interface 345 is a communication path between these accessories and the processor/controller 340.

In an embodiment, the processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes can be made to FIG. 3A. For example, various components in FIG. 3A can be combined, further subdivided or omitted, and additional components can be added according to specific requirements. As an example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

In other implementations, two or more UEs 116 may communicate directly using one or more sidelink channels (for example, without using a base station as a medium for communication with each other). For example, the UE 116 may communicate using peer-to-peer (P2P) communication, device-to-device (D2D) communication, vehicle-to-everything (V2X) protocol (which, for example, may include vehicle-to-vehicle (V2V) protocol, vehicle-to-infrastructure (V2I) protocol, etc.), mesh network, etc. In this case, the UE 116 may perform scheduling operations, resource selection operations, and/or other operations performed by the base station as described elsewhere herein. In another example, the base station may configure the UE 116 via downlink control information (DCI), radio resource control (RRC) signaling, medium access control-control element (MAC-CE) or via system information (e.g., system information block (SIB)).

FIG. 3B illustrates an example gNB 102 according to an embodiment of the disclosure.

The embodiment of the gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that the gNB 101 and the gNB 103 can include the same or similar structures as the gNB 102.

Referring to FIG. 3B, the gNB 102 includes a plurality of antennas 370a, 370b, . . . 370n, a plurality of RF transceivers 372a, 372b, . . . 372n, a transmission (TX) processing circuit 374, and a reception (RX) processing circuit 376. In certain embodiments, one or more of the plurality of antennas 370a, 370b, . . . 370n include a 2D antenna array. The gNB 102 also includes a controller/processor 378, memory 380, and a backhaul or network interface 382.

RF transceivers 372a, 372b, . . . 372n receive an incoming RF signal from antennas 370a, 370b, . . . 370n, such as a signal transmitted by UEs or other gNBs. RF transceivers 372a, 372b, . . . 372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a, 372b, . . . 372n receive the outgoing processed baseband or IF signal from TX processing circuit 374 and up-convert the baseband or IF signal into an RF signal transmitted via antennas 370a, 370b, . . . 370n.

The controller/processor 378 can include one or more processors or other processing devices that control the overall operation of the gNB 102. For example, the controller/processor 378 can control the reception of forward channel signals and the transmission of backward channel signals through the RF transceivers 372a, 372b, . . . 372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in the gNB 102. In some implementations, the controller/processor 378 includes at least one microprocessor or microcontroller.

In an embodiment, the controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some implementations, the controller/processor 378 supports communication between entities such as web RTCs. The controller/processor 378 can move data into or out of the memory 380 as required by an execution process.

In another embodiment, the controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

Described in more detail below, the transmission and reception paths of the gNB 102 (implemented using RF transceivers 372a, 372b, . . . 372n, TX processing circuit 374 and/or RX processing circuit 376) support aggregated communication with FDD cells and TDD cells.

Although FIG. 3B illustrates an example of the gNB 102, various changes may be made to FIG. 3B. For example, the gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a set-top box and other devices.

Example embodiments of the disclosure provide a method performed by a terminal, a terminal, a method performed by a base station, a base station, and a non-transitory computer-readable storage medium in a wireless communication system.

In describing a wireless communication system and in the disclosure described below, transferring methods (or configuration methods) of higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (CE).

In the following description of the example embodiments of the disclosure, higher layer signaling may be signaling corresponding to at least one or a combination of one or more of the following signaling.
master information block (MIB)
system information block (SIB) or SIB X (X=1,2, . . . )
RRC signaling
MAC CE

Physical layer (Layer 1 (L1)) signaling may be signaling corresponding to at least one or a combination of one or more of the following signaling.
physical downlink control channel (PDCCH)
downlink control information (DCI)
UE-specific DCI
group common DCI
common DCI (e.g., multicast DCI)
scheduling DCI (for example, DCI for scheduling downlink or uplink data)
non-scheduling DCI (for example, DCI other than DCI for scheduling downlink or uplink data)
physical uplink control channel (PUCCH)
uplink control information (UCI)
Paging
physical random access channel (PRACH)
random access response (RAR)

In the description of example embodiments, uplink control signaling may include physical layer signaling and/or higher layer signaling. As described above, the physical layer signaling may include UCI and/or PUCCH and/or PRACH, and the higher layer signaling may include RRC signaling and/or MAC CE.

In the embodiments of the disclosure, downlink control signaling may include physical layer signaling and/or higher layer signaling. As mentioned above, the physical layer signaling may include one or more of PDCCH, DCI, UE-specific DCI, group common DCI, common DCI, scheduling DCI (for example, DCI for scheduling downlink or uplink data), non-scheduling DCI, paging, and RAR, and the higher layer signaling may include one or more of a MIB, a SIB or SIB X (X=1, 2, . . . ), RRC signaling or a MAC CE. Therefore, “configuring or indicating X through downlink control signaling” will be understood as configuring or indicating X through physical layer signaling, or configuring or indicating X through higher layer signaling, or configuring or indicating X through a combination of higher layer signaling and physical layer signaling.

It should be noted that all or one or more of the methods, steps, or operations described by the example embodiments of the disclosure may be indicated by protocol specification and/or higher layer signaling configuration and/or dynamic signaling, unless the context clearly indicates otherwise. Dynamic signaling may be PDCCH and/or DCI and/or DCI format. In an example, a semi-persistent scheduling (SPS) physical downlink shared channel (PDSCH) and/or a configured grant (CG) physical uplink shared channel (PUSCH) may be dynamically indicated in its activation DCI/DCI format/PDCCH. All or one or more of the methods, steps, and operations described may be optional. In another example, if a certain parameter (e.g., Parameter X) is configured, the UE performs a certain method (e.g., Method A), otherwise (if the parameter, e.g., Parameter X, is not configured), the UE performs another method (e.g., Method B). If not specifically stated, the parameters in the embodiments of the disclosure may be higher layer parameters. For example, the higher layer parameter may be a parameter configured or indicated by higher layer signaling (e.g., RRC signaling).

It should be noted that the methods described by the example embodiments of the disclosure may be combined in any order. In a combination, a method may be performed one or more times.

It should be noted that the steps of the methods described in the example embodiments of the disclosure may be performed in any order.

In the description of the example embodiments of the disclosure, “performing a predefined method (or step) if a predefined condition is satisfied” and “not performing the predefined method (or step) if the predefined condition is not satisfied” may be used interchangeably. “Not performing a predefined method (or step) if a predefined condition is satisfied” and “performing the predefined method (or step) if the predefined condition is not satisfied” may be used interchangeably.

In the description of example embodiments, a resource, which may also be referred to as a physical resource, may include a time domain resource (or time resource) and/or a frequency domain resource (or frequency resource).

In the description of example embodiments of the disclosure, a “time domain resource” or “time resource” may refer to or be used interchangeably with at least one of symbol(s) (e.g., OFDM symbol(s)), slot(s), subslot(s), mini-slot(s), or subframe(s).

In the description of example embodiments, a “time unit” may refer to a unit of a “time domain resource” or a “time resource”.

In the description of example embodiments, a “frequency domain resource” or “frequency resource” may refer to or be used interchangeably with at least one of the following: channel(s), sub-channel(s), carrier(s), subcarrier(s), resource block(s) (RB(s)), resource element(s) (RE(s)), physical resource block(s) (PRB(s)), or physical resource block group(s) (RBG(s)).

In the description of example embodiments, a “frequency unit” may refer to a unit of a “frequency domain resource” or a “frequency resource”.

Various example embodiments of the disclosure will be described in detail with reference to the accompanying drawings.

Communication systems may include time division duplex (TDD), frequency division duplex (FDD), full duplex systems. In TDD, transmissions in different directions on a given channel are separated from each other using time division multiplexing. In FDD, transmissions in different directions may operate in different carrier frequencies (e.g., within a paired spectrum). Full duplex communications may be implemented within an unpaired spectrum (e.g., within a single carrier bandwidth), where transmissions in different directions (e.g., uplink communications and downlink communications) occur within different subbands of the carrier bandwidth (e.g., a BWP of the carrier bandwidth). This type of full duplex communication may be referred to herein as subband full duplex (SBFD) and may also be referred to as flexible duplex.

In communication systems such as TDD systems, a base station may configure uplink and downlink attributes (or uplink and downlink transmission directions) in different time resources (e.g., respective time resources) on a carrier (the term “carrier” may be interchangeably used with “cell” or “serving cell”) through semi-static signaling and/or dynamic signaling, where the uplink and downlink attributes (or uplink and downlink transmission directions) of each time resource may include uplink, downlink, or flexible. In an example, time resources may include subframes, slots, subslots, symbols, and/or the like. For example, the base station may configure uplink slots/symbols (e.g., OFDM symbols) (for uplink transmissions), downlink slots/symbols (for downlink transmissions), and flexible slots/symbols (for uplink or downlink transmissions) on a carrier through semi-static signaling and/or dynamic signaling. In communication systems such as FDD systems, the base station may configure different time resources (e.g., respective time resources) of an uplink carrier of a pair of uplink and downlink carriers as an uplink slot/symbol or a flexible slot/symbol, respectively, and different time resources (e.g., respective time resources) of a downlink carrier as a downlink transmission slot/symbol or a flexible slot/symbol, respectively. In a slot of a downlink frame, the UE would assume/consider that downlink transmissions occur only in “downlink” symbols or “flexible” symbols. As one example, in a slot of an uplink frame, the UE would transmit only in “uplink” or “flexible” symbols.

In various implementations, the semi-static signaling may be higher layer signaling (e.g., radio resource control (RRC) signaling or other higher layer signaling described in the example embodiments of the disclosure). The dynamic signaling may be downlink control information (DCI) (e.g., carried by a physical downlink control channel (PDCCH)). For example, the dynamic signaling may be a group common DCI without scheduling a physical downlink shared channel (PDSCH) and a physical uplink shared channel (PUSCH). The dynamic signaling may also be a DCI scheduling a PDSCH and a PUSCH. Or, the dynamic signaling may be other dynamic signaling described in the example embodiments of the disclosure.

Compared to FDD systems, the time delay for uplink or downlink transmissions is relatively large in TDD systems because the uplink and downlink transmissions are time division multiplexed. For example, according to an uplink and downlink configuration, in a period of 10 ms (milliseconds), only a slot of 1 ms is for uplink transmission, the other slots are for downlink transmission or flexible transmission, and the uplink transmission has a maximum delay of 10 ms. In order to reduce transmission delay, it may be considered to configure a part of frequency domain resources in a carrier for uplink transmission and another part for downlink transmission. The interaction of uplink and downlink transmissions in the same carrier (uplink and downlink interference) can be reduced by setting a guard period.

In a communication system, a UE may receive a reference signal and perform channel measurement based on the reference signal and estimate a channel state based on the channel measurement to obtain channel state information (CSI). The UE may determine (e.g., calculate or derive) a CSI parameter and send a CSI report that includes the CSI parameter. In embodiments of the disclosure, the reference signal is explained taking the CSI-RS as an example. The embodiments of the disclosure are not limited thereto, and the reference signal for measurement may also be other types of reference signals such as a demodulation reference signal (DM-RS) or a phase tracking reference signal (PT-RS). The CSI may include one or more of a channel quality indicator (CQI), a precoding matrix indicator (PMI), a CSI-RS resource indicator (CRI), a synchronization signal (SS)/physical broadcast channel (PBCH) block resource indicator (SSBRI), a layer indicator (LI), a rank indicator (RI), a reference signal receiving power (RSRP), or a signal-to-interference-plus-noise ratio (SINR).

For full-duplex communication, enhancements to CSI-related procedures, such as methods of determination of CSI or reporting of CSI parameters, etc., are needed to improve the performance of CSI feedback.

Example embodiments of the disclosure provides an enhanced CSI feedback method. Based on the uplink and downlink transmission modes described in the example embodiments of the disclosure, the transmission performance of data can be guaranteed and the resources can be utilized as best as possible on the premise that the data transmission performance is guaranteed.

In TDD systems, a base station may indicate that a time unit (e.g., a time unit may include one or more slots, or one or more symbols) is an uplink slot/symbol, or a downlink slot/symbol, or a flexible slot/symbol. In the description of example embodiments, “time unit”, “slot(s)”, “symbol(s)” may be used interchangeably.

A UE may determine the uplink and downlink transmission direction of each symbol/slot of a carrier/serving cell based on the indication of the base station. For example, the UE may receive cell-common signaling (e.g., cell-common UL/DL information such as tdd-UL-DL-ConfigurationCommon) to determine whether a time unit is an uplink slot/symbol, or a downlink slot/symbol, or a flexible slot/symbol. For another example, the UE may receive UE-specific signaling (e.g., UE-specific UL/DL information such as tdd-UL-DL-ConfigurationDedicated) to determine whether a time unit is an uplink slot/symbol, or a downlink slot/symbol, or a flexible slot/symbol.

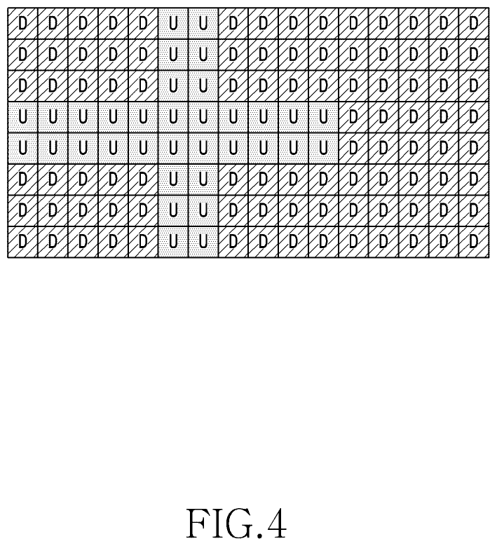

As a more efficient allocation of uplink and downlink transmission resources, the granularity of uplink and downlink transmission resources can be further reduced from all frequency domain resources of a symbol/slot to partial frequency domain resources within the symbol/slot by configuration information (e.g., semi-static signaling, such as high layer signaling); for example, different frequency domain resources in a symbol of a carrier/serving cell may be configured with different transmission directions. The configuration information (e.g., semi-static signaling, such as higher layer signaling) may include cell-common UL/DL information (e.g., tdd-UL-DL-ConfigurationCommon) and/or UE-specific UL/DL information (e.g., tdd-UL-DL-ConfigurationDedicated). The cell-common UL/DL information may include information on downlink and uplink attributes in a time dimension and a frequency domain dimension. For example, cell-common UL/DL information may be used to indicate which frequency domain resources of which slots/symbols are resources for uplink, downlink, or flexible transmission; or, the cell-common UL/DL information may be used to indicate which frequency domain resources of which slots/symbols are uplink resources, downlink resources, or resources unavailable for transmission (e.g., the resources unavailable for transmission may be guard bands). The cell-specific UL/DL information may include information on downlink and uplink attributes in the time dimension and the frequency domain dimension. In an example, the cell-specific UL/DL information may be used to indicate which frequency domain resources of which slots/symbols are resources for uplink, downlink, or flexible transmission; or, the cell-specific UL/DL information may be used to indicate which frequency domain resources of which slots/symbols are uplink resources, downlink resources, or resources unavailable for transmission (e.g., the resources unavailable for transmission are guard bands). FIG. 4 illustrates a schematic diagram of an uplink-downlink configuration according to an embodiment of the disclosure. Referring to FIG. 4, “D” indicates a downlink symbol and “U” indicates an uplink symbol.

The UE may determine a symbol or slot in which a part of the frequency-domain resources are uplink transmission resources and a part of the frequency-domain resources are downlink transmission resources according to the configured UL/DL information. In an example, such symbol or slot may be referred to as an SBFD symbol or SBFD slot. According to the configured UL/DL information, the UE may also determine that all frequency domain resources within a symbol or slot are uplink transmission resources, or may determine that all frequency domain resources within a symbol or slot are downlink transmission resources. The UL/DL information may be transmitted to the UE via semi-static signaling (e.g., higher layer signaling). The UE may determine one or more SBFD symbols or SBFD slots based on the UL/DL information (e.g., cell-common UL/DL information and/or UE-specific UL/DL information and/or SBFD configuration information and/or other information). For example, the UE may perform uplink transmission and downlink reception in an SBFD symbol or SBFD slot simultaneously (e.g., in different frequency domain resources (e.g., subbands) of the SBFD symbol or SBFD slot). The SBFD configuration information may indicate that one or more SBFD symbols are configured/indicated. For example, the SBFD configuration information may indicate one or more SBFD symbols among downlink symbols or flexible symbols (e.g., downlink symbols or flexible symbols configured/indicated by higher layer signaling such as cell-common UL/DL information and/or UE-specific UL/DL information). The SBFD symbol or the SBFD slot may be configured by various methods. As one example, the SBFD configuration information may configure SBFD symbols or SBFD slots by cell-common SBFD configuration information or configure SBFD symbols or SBFD slots by UE-specific SBFD configuration information independently of cell-common UL/DL information (e.g., tdd-UL-DL-ConfigurationCommon) and/or UE-specific UL/DL information (e.g., tdd-UL-DL-ConfigurationDedicated). As another example, the SBFD configuration information may be included in cell-common UL/DL information (e.g., tdd-UL-DL-ConfigurationCommon) and/or UE-specific UL/DL information (e.g., tdd-UL-DL-ConfigurationDedicated).

The UE may be configured with a frequency band for transmission and/or reception. For example, the frequency band for transmission and/or reception may be referred to as an uplink BWP and/or downlink BWP, or any other suitable name. When more than one uplink BWP and/or downlink BWP is configured for the UE, the active uplink BWP and/or active downlink BWP may be an uplink BWP and/or downlink BWP currently transmitted and/or received by the UE.

The UE may report channel state information (CSI). For example, the UE may report the CSI to the base station. The UE may obtain the CSI based on a channel state information-reference signal (CSI-RS) (e.g., by measuring in a CSI-RS resource). Here, the UE may obtain the configuration of the CSI-RS by receiving higher layer signaling or other signaling. The CSI-RS configuration includes a frequency domain configuration of the CSI-RS including a band bandwidth and a band position of the CSI-RS and a time domain configuration of the CSI-RS including a period and a starting position of the CSI-RS.

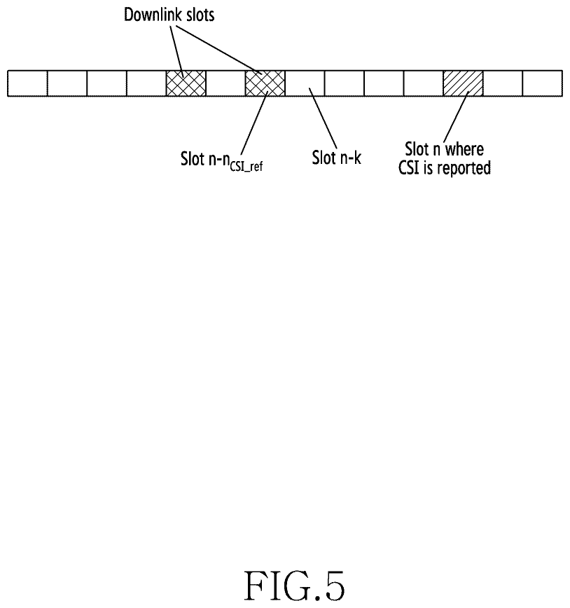

FIG. 5 illustrates a schematic diagram of timing of CSI reporting according to an embodiment of the disclosure.

Referring to FIG. 5, a UE may report CSI in slot n, and the UE may measure a CSI-RS in slot n-n_{CSI_ref} to obtain CSI, where n_{CSI_ref} is the smallest value greater than or equal to k, such that slot n-n_{CSI_ref} is a valid downlink slot. Optionally, k is a parameter related to delay requirement (e.g., CSI computation delay requirement).

A valid downlink slot may be defined as follows: a slot is a valid downlink slot if the slot includes at least one higher layer configured downlink symbol or flexible symbol and/or the slot does not fall within (e.g., is not included in) a measurement gap.

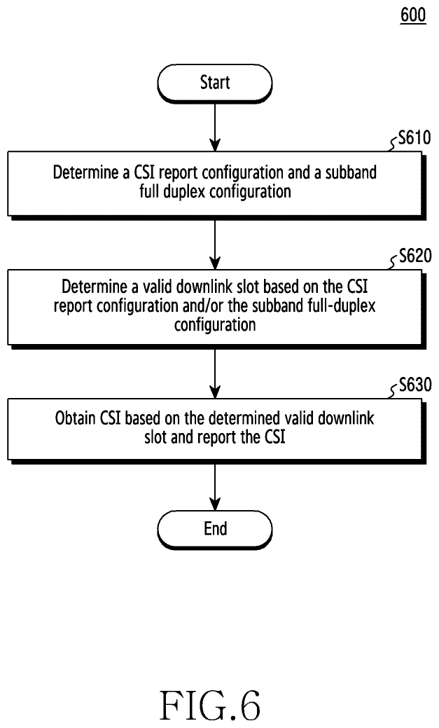

FIG. 6 illustrates a flowchart 600 of CSI reporting of a UE according to an embodiment of the disclosure.

Referring to the flowchart 600 of CSI reporting of the UE of FIG. 6, the UE receives a CSI report configuration and an SBFD configuration in operation 8610. For example, the UE may receive the CSI report configuration and the SBFD configuration via higher layer signaling. For example, the SBFD configuration may indicate one or more SBFD symbols. The SBFD configuration may indicate one or more SBFD symbols of higher layer configured downlink symbols and/or flexible symbols.

In some implementations, the CSI report configuration may include a configuration of resources for transmission of CSI (e.g., PUCCH) and/or a configuration of resources for measurement of CSI (e.g., CSI-RS resources).

Referring to FIG. 6, in operation S620, the UE determines valid downlink slot(s) based on the CSI report configuration and the SBFD configuration.

Next, in operation S630, the UE determines CSI based on the determined valid downlink slot(s), and the UE reports the CSI. For example, the UE may report the CSI to a base station.

In some implementations, in operation S630, the UE may measure the CSI in the determined valid downlink slot(s) to obtain the CSI.

In other implementations, the valid downlink slot(s) may be determined according to one or more aspects of Method I and/or Method II below.

### Method I

The UE receives a CSI report configuration. The CSI report configuration may include a configuration (e.g., PUCCH configuration) of uplink slot n in which CSI is reported. The UE may derive CSI by measuring a CSI-RS. The UE measures a CSI-RS based on slot n-n_{CSI_ref} (e.g., measuring a CSI-RS in slot n-n_{CSI_ref} or slot n-n_{CSI}_{_{ref}}-offset; for example, the offset may be equal to

$${K}_{offset} \cdot \frac{{2}^{{μ}_{D L}}}{{2}^{{μ}_{{K}_{offset}}}} ,$$

K_{offset} is an offset parameter configured by higher layers, μ_{DL} is a downlink subcarrier spacing configuration, and μ_{K}_{_{offset}} is a subcarrier spacing configuration with K_{offset} of value 0 (e.g., for frequency range 1)), where n_{CSI_ref} is the smallest value greater than or equal to k (e.g., k is a parameter related to delay requirement), such that slot n-n_{CSI_ref} is a valid downlink slot. In such, the UE may report the CSI in slot n. For example, the UE may report the CSI to the base station.

In an example, a valid downlink slot may be defined as follows: a slot is a valid downlink slot if the slot includes at least one higher layer configured downlink symbol or flexible symbol and/or the slot does not fall within (e.g., is not included in) a measurement gap (e.g., a configured measurement gap).

In an implementations, a downlink symbol or flexible symbol may be configured as an SBFD symbol which includes an uplink band and/or a guard band. For example, the uplink band and/or guard band in the SBFD symbol may not be used for CSI measurement.

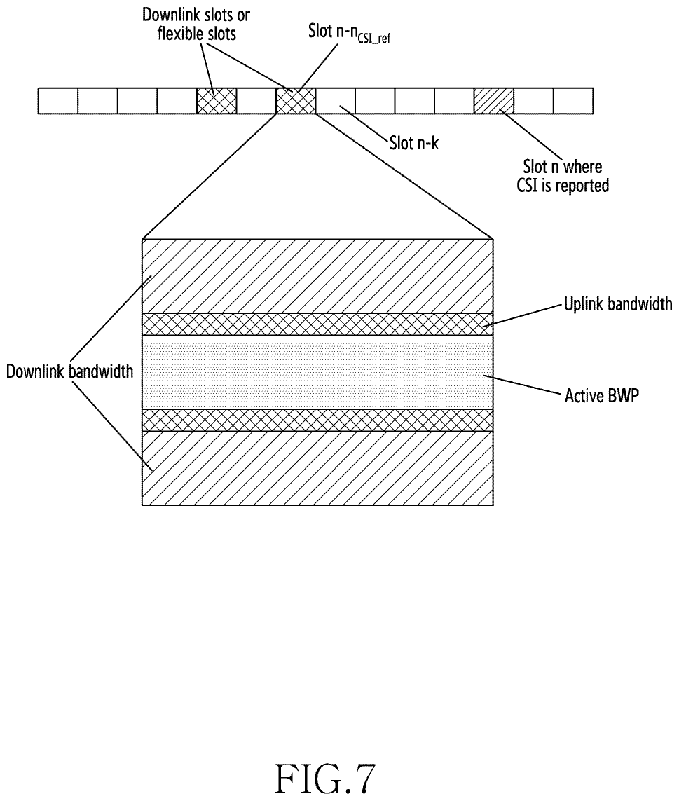

If the active downlink BWP of the UE is in the SBFD symbol, the active downlink BWP is completely included in the uplink band and/or guard band in the SBFD symbol, in which case the SBFD symbol cannot be used for CSI measurement. Consider the definition of a valid downlink slot as follows: if a slot includes at least one higher layer configured downlink symbol or flexible symbol and/or includes at least one higher layer configured downlink symbol or flexible symbol configured as SBFD, and the slot does not fall within (e.g., is not included in) a measurement gap, then the slot is a valid downlink slot. In this case, when the active downlink BWP is completely included within the uplink band and/or guard band in the SBFD symbol, a valid downlink slot may not be available for CSI measurement, resulting in a wasted opportunity for corresponding CSI reporting. FIG. 7 illustrates a diagram of a valid downlink slot according to an embodiment of the disclosure. Referring to FIG. 7, a symbol configured/indicated as SBFD (SBFD symbol) is included in slot n-n_{CSI_ref} of downlink slots or flexible slots, the active downlink BWP is completely included within an uplink band and/or a guard band in the SBFD symbol. If a valid downlink slot is determined based on slot n-n_{CSI_ref}(e.g., slot n-n_{CSI_ref} is determined as a valid downlink slot), CSI measurement cannot be made in slot n-n_{CSI_ref}, resulting in a wasted opportunity to report CSI in slot n.

In other implementations, a slot is a valid downlink slot if it satisfies one or more or all of the following conditions: (i) the slot includes at least one higher layer configured downlink symbol or flexible symbol; (ii) the slot includes at least one SBFD symbol (e.g., including a higher layer configured downlink symbol or flexible symbol configured as SBFD); (iii) the active downlink BWP is not completely included within the uplink band and/or guard band in the SBFD symbol; (vi) the slot does not fall within (e.g., is not included in) a measurement gap.

A valid downlink slot may be defined as follows: if a slot includes at least one higher layer configured downlink symbol or flexible symbol or the slot includes at least one higher layer configured downlink symbol or flexible symbol configured as SBFD, and the slot does not fall within (e.g., is not included in) the measurement gap and the active downlink BWP is not completely included within the uplink band and/or guard band in the SBFD symbol, then the slot is a valid downlink slot.

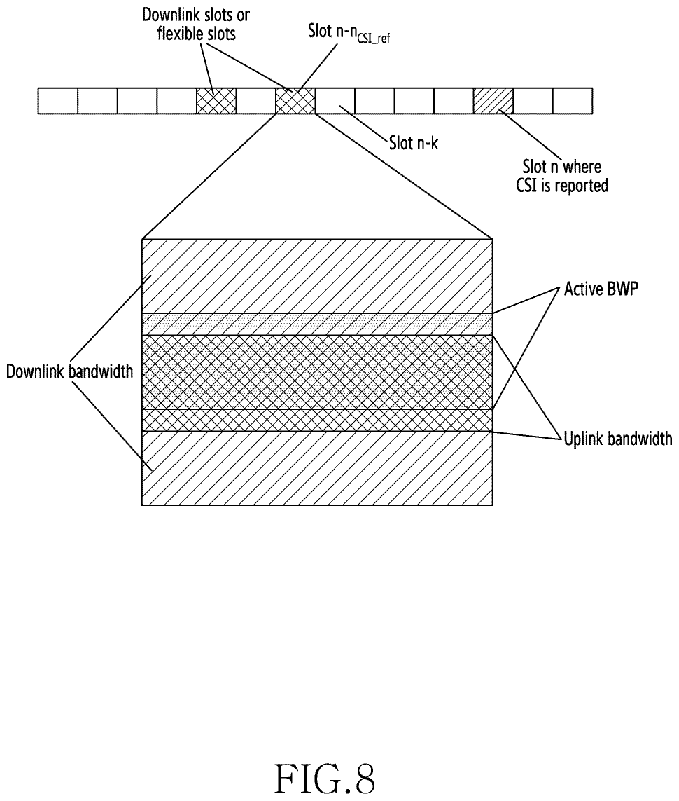

FIG. 8 illustrates a diagram of a valid downlink slot according to an embodiment of the disclosure. Referring to FIG. 8, a downlink symbol configured/indicated as SBFD (SBFD symbol) is included in slot n-n_{CSI_ref} of downlink slots or flexible slots, the active downlink BWP is not completely included within an uplink band and/or guard band in the SBFD symbol, the UE can perform CSI measurement based on slot n-n_{CSI_ref} (e.g., in slot n-n_{CSI_ref} determined to be a valid downlink slot) and report CSI in slot n.

In another example, a valid downlink slot may be determined based on the following: if a slot includes at least one higher layer configured downlink symbol or flexible symbol configured as SBFD and the slot does not fall within (e.g., is not included in) the measurement gap, and the active downlink BWP is completely included within the uplink band and/or guard band in the SBFD symbol, then the slot is not a valid downlink slot. Referring back to FIG. 7, a downlink symbol configured/indicated as SBFD (i.e., SBFD symbol) is included in slot n-n_{CSI_ref} of downlink slots or flexible slots, the active downlink BWP is completely included within the uplink band and/or guard band in the SBFD symbol, then slot n-n_{CSI_ref} is not a valid downlink slot or is not determined to be a valid downlink slot.

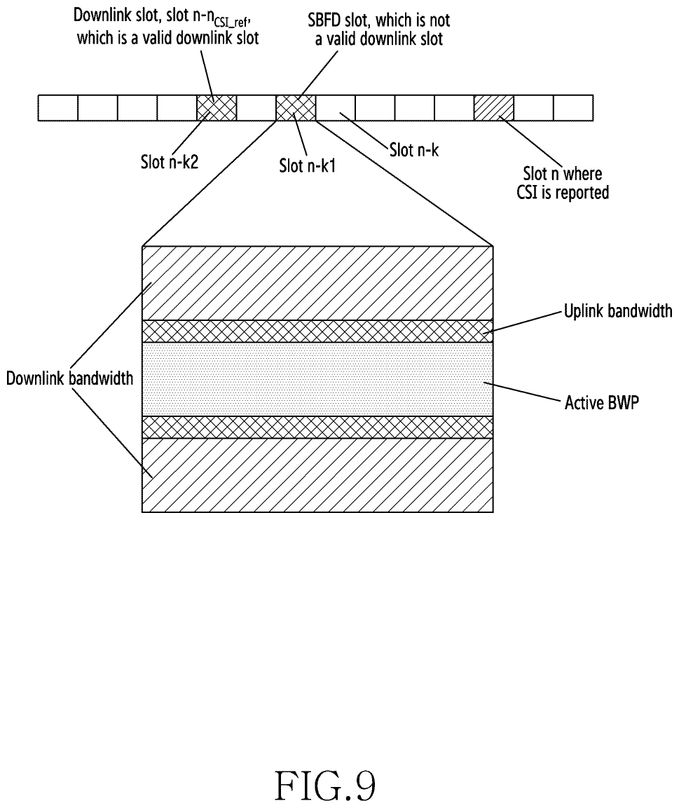

FIG. 9 illustrates a diagram of a valid downlink slot according to an embodiment of the disclosure. Referring to FIG. 9, the UE reports CSI in slot n. The UE measures a CSI-RS based on slot n-n_{CSI_ref} (e.g., measures a CSI-RS in slot n-n_{CSI_ref}) for CSI, where n-n_{CSI_ref} is the smallest value greater than or equal to k (e.g., k is a parameter related to delay requirement), such that slot n-n_{CSI_ref} is a valid downlink slot. Referring to FIG. 9, slot n-k1 of downlink slots or flexible slots includes a downlink symbol configured/indicated (e.g., by higher layer signaling) as SBFD (i.e., SBFD symbol), the active downlink BWP is completely included within the uplink band and/or guard band in the SBFD symbol, then the slot is not a valid downlink slot. Slot n-k2 of downlink slots or flexible slots includes downlink symbols configured/indicated (e.g., by higher layer signaling) as non-SBFD, then the slot is a valid downlink slot. The UE may perform measurement based on (e.g., in) slot n-k2 (i.e., slot n-n_{CSI_ref}) to obtain CSI.

By the method, a valid downlink slot is determined in consideration of the SBFD, and the effectiveness of the CSI report can be improved.

It should be noted that in the example embodiments of the disclosure described in connection with FIGS. 6 to 9, as well as some other embodiments of the disclosure, when describing the time domain resources for measuring the reference signals of CSI (e.g., CSI-RS), the downlink transmission offset may not be considered for the sake of brevity. It can be understood that the example embodiments of the disclosure are equally applicable to scenarios where the downlink transmission offset is considered. For example, in the example embodiments of the disclosure, “measuring the CSI-RS of slot n-n_{CSI_ref}” or “measuring the CSI-RS in slot n-n_{CSI_ref}” may be replaced with “measuring the CSI-RS of slot n-n_{CSI}_{_{ref}}-offset” or “measuring the CSI-RS in slot n-n_{CSI}_{_{ref}}-offset”. For example, the offset may be equal to

$${K}_{offset} \cdot \frac{{2}^{{μ}_{D L}}}{{2}^{{μ}_{{K}_{offset}}}} ,$$

where K_{offset} is an offset parameter configured by higher layers, μ_{DL} is a downlink subcarrier spacing configuration, μ_{K}_{_{offset}} is a subcarrier spacing configuration with K_{offset} of value 0 (e.g., for frequency range 1).

### Method II

The UE may receive a CSI report configuration. The CSI report configuration may include a configuration of uplink slot n where CSI is reported (e.g., a PUCCH configuration, such as resources for PUCCH where CSI is reported). The UE may derive CSI by measuring a CSI-RS. The UE measures a CSI-RS based on slot n-n_{CSI_ref} (e.g., measuring a CSI-RS in slot n-n_{CSI_ref} or slot n-n_{CSI}_{_{ref}}-offset; for example, the offset may be equal to

$${K}_{offset} \cdot \frac{{2}^{{μ}_{D L}}}{{2}^{{μ}_{{K}_{offset}}}} ,$$

where K_{offset} is an offset parameter configured by higher layers, μ_{DL} is a downlink subcarrier spacing configuration, μ_{K}_{_{offset}} is a subcarrier spacing configuration with K_{offset} of value 0 (e.g., for frequency range 1)), where n_{CSI_ref} is the smallest value greater than or equal to k (e.g., k is a parameter related to delay requirement), such that slot n-n_{CSI_ref} is a valid downlink slot. In such, the UE may report the CSI in slot n. For example, the UE may report the CSI to the base station.

For example, a valid downlink slot may be defined as follows: a slot is a valid downlink slot if the slot includes at least one higher layer configured downlink symbol or flexible symbol and/or the slot does not fall within (e.g., is not included in) a measurement gap.

A downlink symbol or flexible symbol may be configured as SBFD symbol which includes an uplink band and/or guard band. For example, the uplink band and/or guard band in the SBFD symbol may not be used for CSI measurement.

In an embodiment, if the active downlink BWP of the UE is in an SBFD symbol, and the proportion of the uplink band and/or guard band in the SBFD symbol included in the active downlink BWP (e.g., the ratio of the uplink band and/or guard band in the SBFD symbol included in the active downlink BWP to the uplink band and/or guard band in the SBFD symbol) is large (e.g., greater than or equal to a threshold of alpha), the SBFD symbol may result in inaccurate performance of the CSI measurement. Consider the definition of a valid downlink slot as follows: a slot is a valid downlink slot if the slot includes at least one higher layer configured downlink symbol or flexible symbol and/or includes at least one higher layer configured downlink symbol or flexible symbol configured as SBFD and the slot does not fall within a measurement gap. In this case, when the proportion of the uplink band and/or guard band in the SBFD symbol included in the active downlink BWP is large (e.g., greater than the threshold alpha), the performance of the CSI measurement in the valid downlink slot may be inaccurate.

In some implementations, a slot is a valid downlink slot if it satisfies one or more, or all of the following conditions: (i) the slot includes at least one higher layer configured downlink symbol or flexible symbol; (ii) the slot includes at least one SBFD symbol (e.g., including a higher layer configured downlink symbol or flexible symbol configured as SBFD); (iii) the proportion of the uplink band and/or guard band in the SBFD symbol included in the active downlink BWP (e.g., the ratio of the uplink band and/or guard band in the SBFD symbol included in the active downlink BWP to the uplink band and/or guard band in the SBFD symbol) is less than or equal to a threshold alpha; (vi) the slot does not fall within (e.g., is not included in) a measurement gap.

A valid downlink slot may be defined as follows: if a slot includes at least one higher layer configured downlink symbol or flexible symbol or includes at least one higher layer configured downlink symbol or flexible symbol configured as SBFD, and the slot does not fall within (e.g., is not included in) a measurement gap, and the proportion of the uplink band and/or guard band in the SBFD symbol included in the active downlink BWP is less than or equal to a threshold alpha, then the slot is a valid downlink slot.

Additionally or alternatively, for another example, if a slot includes at least one higher layer configured downlink symbol or flexible symbol configured as SBFD and the slot does not fall within a measurement gap, and when the proportion of the uplink band and/or guard band in the SBFD symbol included in the active downlink BWP is greater than a threshold alpha, then the slot is not a valid downlink slot. For example, the threshold alpha may be specified by protocols or configured by the base station. Referring back to FIG. 7, a downlink symbol configured/indicated as SBFD (e.g., SBFD symbol) is included in slot n-n_{CSI_ref} of downlink slots or flexible slots. The slot is not a valid downlink slot or may not be determined to be a valid downlink slot if the proportion of the uplink band and/or guard band in the SBFD symbol included in the active downlink BWP is greater than a threshold alpha.

Referring back to FIG. 9, the UE reports CSI in slot n. The UE measures a CSI-RS based on slot n-n_{CSI_ref} (e.g., measures a CSI-RS in slot n-n_{CSI_ref}) to obtain CSI, where n_{CSI_ref} is the smallest value greater than or equal to k (e.g., k is a parameter related to delay requirement), such that slot n-n_{CSI_ref} is a valid downlink slot. As shown in FIG. 9, slot n-k1 of downlink slots or flexible slots includes a downlink symbol configured/indicated (e.g., by higher layer signaling) as SBFD (i.e., SBFD symbol), the proportion of the uplink band and/or guard band in the SBFD symbol included in the active downlink BWP is greater than a threshold alpha, and thus the slot is not a valid downlink slot. Slot n-k2 of downlink slots or flexible slots includes downlink symbols configured/indicated (e.g., by higher layer signaling) as non-SBFD, and thus the slot is a valid downlink slot. The UE performs measurement based on (e.g., performs measurement in) slot n-k2 (i.e., slot n-n_{CSI_ref}) to obtain CSI, and reports the CSI in slot n.

By the method, a valid downlink slot is determined in consideration of the SBFD, and the effectiveness of the CSI report can be improved.

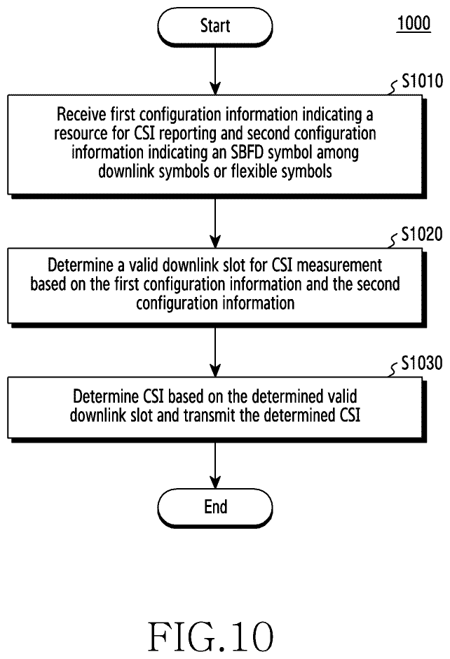

FIG. 10 illustrates a flowchart of a method 1000 performed by a terminal according to an embodiment of the disclosure.

Referring to FIG. 10, in operation S1010, the terminal receives first configuration information indicating a resource for CSI reporting and second configuration information indicating an SBFD symbol among downlink symbols or flexible symbols. For example, the terminal may receive the first configuration information and the second configuration information from the base station.

Next, in operation S1020, the terminal determines a valid downlink slot for CSI measurement based on the first configuration information and the second configuration information.

Then, in operation S1030, the terminal determines CSI based on the determined valid downlink slot and transmits the determined CSI. For example, the terminal may transmit the determined CSI to the base station.

In other implementations, one or more of operations S1010 to S1030 may be performed based on methods described according to various embodiments of the disclosure (e.g., the example embodiments described in connection with FIGS. 4 to 9, and the various manners/methods described above, such as in Methods I-II).

In still other implementations, the method 1000 may omit one or more of operations S1010 to S1020, or may include additional operations, for example, operations that may be performed by a terminal (e.g., UE) described according to various embodiments of the disclosure (e.g., example embodiments described in connection with FIGS. 4 to 9, and various manners/methods described above, such as Methods I-II).

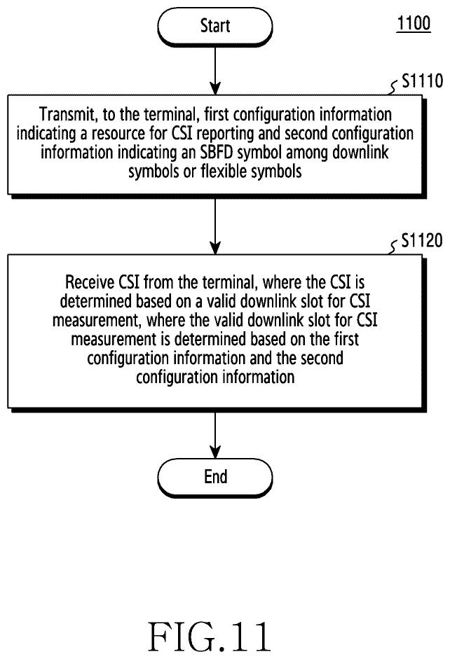

FIG. 11 illustrates a flowchart of a method 1100 performed by a base station according to an embodiment of the disclosure.

Referring to FIG. 11, in operation S1110, the base station transmits, to the terminal, first configuration information indicating a resource for CSI reporting and second configuration information indicating an SBFD symbol among downlink symbols or flexible symbols.

Next, in operation S1120, the base station receives CSI from the terminal. Here, the CSI is determined based on a valid downlink slot for CSI measurement, where the valid downlink slot for CSI measurement is determined based on the first configuration information and the second configuration information.

In some implementations, one or more of S1110 to operation S1120 may be performed based on the methods described according to various embodiments of the disclosure (e.g., the example embodiments described in connection with FIGS. 4 to 9, and the various manners/methods described above, such as in Methods I-II).

In other implementations, the method 1100 may omit one or more of operations S1110 to S1120, or may include additional operations, for example, operations that may be performed by implementations as described in accordance with various of the disclosure (e.g., the example embodiments described in connection with FIGS. 4 to 9, and the various manners/methods described above, such as Methods I-II).

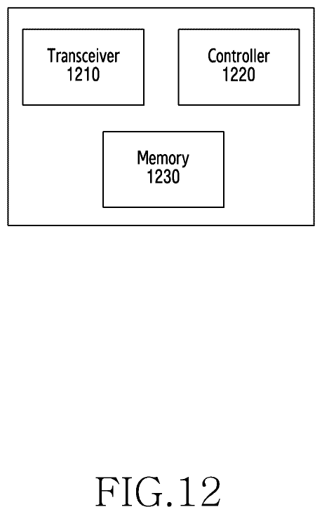

FIG. 12 is a block diagram of a configuration of a first node (e.g., a terminal) as a scheduled node according to an embodiment of the disclosure.

Referring to FIG. 12, the first node includes a transceiver 1210, a controller 1220, and memory 1230. The controller 1220 may refer to a circuit, an application specific integrated circuit (ASIC), or at least one processor. The transceiver 1210, the controller 1220, and the memory 1230 are configured to perform the above-described operations that can be performed by the terminal or the UE. Although the transceiver 1210, the controller 1220, and the memory 1230 are shown as separate entities, they may be implemented as a single entity, such as a single chip. Alternatively, the transceiver 1210, the controller 1220, and the memory 1230 may be electrically connected or coupled to each other.

The transceiver 1210 may transmit and receive signals to and from other network entities (e.g., a base station).

The controller 1220 may control the first node to perform a function according to one of the various example embodiments described above.

In some example embodiments, the operations of the first node may be implemented using memory 1230 storing respective program codes. Specifically, the first node may be equipped with memory 1230 to store program code implementing desired operations. In order to perform desired operations, the controller 1220 may read and execute program codes stored in the memory 1230 by using at least one processor or central processing unit (CPU).

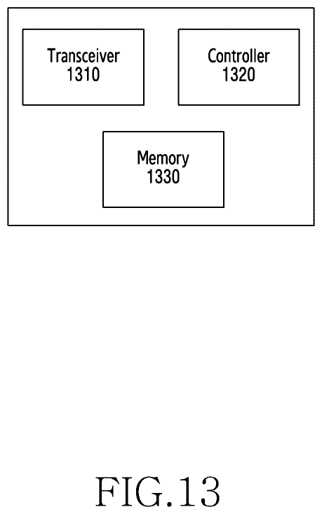

FIG. 13 is a block diagram of a configuration of a second node (e.g., a base station) as a scheduling node according to an embodiment of the disclosure.

Referring to FIG. 13, the second node includes a transceiver 1310, a controller 1320, and memory 1330. The controller 1320 may refer to a circuit, an application specific integrated circuit (ASIC), or at least one processor. The transceiver 1310, the controller 1320, and the memory 1330 are configured to perform the operations described above that can be performed by the base station. Although the transceiver 1310, the controller 1320, and the memory 1330 are shown as separate entities, they may be implemented as a single entity, such as a single chip. Alternatively, the transceiver 1310, the controller 1320, and the memory 1330 may be electrically connected or coupled to each other.

In an embodiment, the transceiver 1310 may transmit and receive signals to and from other network entities (e.g., terminals).

The controller 1320 may control the second node to perform a function according to one of the various example embodiments described above.

In some example embodiments, the operations of the second node may be implemented using memory 1330 storing respective program codes. In particular, the second node may be equipped with memory 1330 to store program code implementing desired operations. In order to perform desired operations, the controller 1320 may read and execute program codes stored in the memory 1330 by using at least one processor or central processing unit (CPU).

Those skilled in the art will understand that the above illustrative embodiments are described herein and are not intended to be limiting. It should be understood that any two or more of the embodiments disclosed herein may be combined in any combination. Other embodiments may be utilized and other changes may be made without departing from the spirit and scope of the subject matter presented herein. It will be readily understood that aspects of the disclosure as generally described herein and shown in the drawings may be arranged, replaced, combined, separated and designed in various different configurations, all of which are contemplated herein.

Those skilled in the art will understand that the various illustrative logic blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described function sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, multiple microprocessors, one or more microprocessors cooperating with a DSP core, or any other such configuration.

The steps of the method or algorithm described in this application may be embodied directly in hardware, in a software module executed by a processor, or in a combination thereof. The software module may reside in a RAM memory, a flash memory, a ROM memory, an EPROM memory, an EEPROM memory, a register, a hard disk, a removable disk, or any other form of storage medium known in the art. A storage medium is coupled to a processor to enable the processor to read and write information from/to the storage medium. In an alternative, the storage medium may be integrated into the processor. The processor and the storage medium may reside in an ASIC. The ASIC may reside in a communication apparatus (e.g., a terminal or a base station). In an alternative, the processor and the storage medium may reside in a communication apparatus (e.g., a terminal or a base station) as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that may be accessed by a general purpose or special purpose computer.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station (BS), first configuration information indicating a resource for channel state information (CSI) reporting and second configuration information indicating a subband full duplex (SBFD) symbol among downlink symbols or flexible symbols;
determining a valid downlink slot for CSI measurement based on the first configuration information and the second configuration information;
determining CSI based on the determined valid downlink slot; and
transmitting, to the BS, the determined CSI.

2. The method of claim 1,
wherein the determining the valid downlink slot for CSI measurement based on the first configuration information and the second configuration information includes determining a valid downlink slot based on a slot n-n_{CSI_ref},
wherein n is an index of an uplink slot for transmitting the CSI determined based on the first configuration information,
wherein n_{CSI_ref} is determined based on the first configuration information and the second configuration information, and
wherein n_{CSI_ref} is a smallest value greater than or equal to a parameter related to delay requirement, such that the slot n-n_{CSI_ref} is a valid downlink slot.

3. The method of claim 2, wherein determining CSI based on the determined valid downlink slot includes measuring a reference signal in slot n-n_{CSI_ref} to obtain the CSI.

4. The method of claim 1, wherein a slot including at least one downlink symbol or flexible symbol and not included in a measurement gap for the UE is determined as the valid downlink slot.

5. The method of claim 1,
wherein a slot including at least one SBFD symbol is determined as the valid downlink slot, and
wherein an active downlink BWP is not completely included within an uplink band and/or guard band in the SBFD symbol, or
wherein a slot including at least one SBFD symbol and not included in a measurement gap for the UE is determined as the valid downlink slot, and
wherein an active downlink BWP is not completely included within an uplink band and/or guard band in the SBFD symbol.

6. A method performed by a base station (BS) in a wireless communication system, the method comprising:
transmitting, to a user equipment (UE), first configuration information indicating a resource for channel state information (CSI) reporting and second configuration information indicating a subband full duplex (SBFD) symbol among downlink symbols or flexible symbols; and
receiving, from the UE, CSI,
wherein the CSI is determined based on a valid downlink slot for CSI measurement, and
wherein the valid downlink slot for CSI measurement is determined based on the first configuration information and the second configuration information.

7. The method of claim 6,
wherein the valid downlink slot is determined based on a slot n-n_{CSI_ref},
wherein n is an index of an uplink slot for transmitting the CSI determined based on the first configuration information,
wherein n_{CSI_ref} is determined based on the first configuration information and the second configuration information, and
wherein n_{CSI_ref} is a smallest value greater than or equal to a parameter related to delay requirement, such that the slot n-n_{CSI_ref} is a valid downlink slot.

8. The method of claim 7, wherein the CSI is obtained by measurement of a reference signal in slot n-n_{CSI_ref}.

9. The method of claim 6, wherein a slot including at least one downlink symbol or flexible symbol and not included in a measurement gap for the UE is determined as the valid downlink slot.

10. The method of claim 6,
wherein a slot including at least one SBFD symbol is determined as the valid downlink slot, and
wherein an active downlink BWP is not completely included within an uplink band and/or guard band in the SBFD symbol, or
wherein a slot including at least one SBFD symbol and not included in a measurement gap for the UE is determined as the valid downlink slot, and
wherein an active downlink BWP is not completely included within an uplink band and/or guard band in the SBFD symbol.

11. A user equipment (UE) in a wireless communication system, the UE comprising:
a transceiver; and
one or more processors coupled with the transceiver and configured to:
receive, from a base station (BS), first configuration information indicating a resource for channel state information (CSI) reporting and second configuration information indicating a subband full duplex (SBFD) symbol among downlink symbols or flexible symbols,
determine a valid downlink slot for CSI measurement based on the first configuration information and the second configuration information,
determine CSI based on the determined valid downlink slot, and
transmit, to the BS, the determined CSI.

12. The UE of claim 11,
wherein the determining the valid downlink slot for CSI measurement based on the first configuration information and the second configuration information includes determining a valid downlink slot based on a slot n-n_{CSI_ref},
wherein n is an index of an uplink slot for transmitting the CSI determined based on the first configuration information,
wherein n_{CSI_ref} is determined based on the first configuration information and the second configuration information, and
wherein n_{CSI_ref} is a smallest value greater than or equal to a parameter related to delay requirement, such that the slot n-n_{CSI_ref} is a valid downlink slot.

13. The UE of claim 12, wherein the determining the CSI based on the determined valid downlink slot includes measuring a reference signal in slot n-n_{CSI_ref} to obtain the CSI.

14. The UE of claim 11, wherein a slot including at least one downlink symbol or flexible symbol and not included in a measurement gap for the UE is determined as the valid downlink slot.

15. The UE of claim 11,
wherein a slot including at least one SBFD symbol is determined as the valid downlink slot, and
wherein an active downlink BWP is not completely included within an uplink band and/or guard band in the SBFD symbol; or
wherein a slot including at least one SBFD symbol and not included in a measurement gap for the UE is determined as the valid downlink slot, and
wherein an active downlink BWP is not completely included within an uplink band and/or guard band in the SBFD symbol.

16. A base station (BS) in a wireless communication system, the BS comprising:
a transceiver; and
one or more processors coupled with the transceiver and configured to:
transmit, to a user equipment (UE), first configuration information indicating a resource for channel state information (CSI) reporting and second configuration information indicating a subband full duplex (SBFD) symbol among downlink symbols or flexible symbols, and
receive, from the UE, CSI,
wherein the CSI is determined based on a valid downlink slot for CSI measurement, and
wherein the valid downlink slot for CSI measurement is determined based on the first configuration information and the second configuration information.

17. The BS of claim 16,
wherein the valid downlink slot is determined based on a slot n-n_{CSI_ref},
wherein n is an index of an uplink slot for transmitting the CSI determined based on the first configuration information,
wherein n_{CSI_ref} is determined based on the first configuration information and the second configuration information, and
wherein n_{CSI_ref} is a smallest value greater than or equal to a parameter related to delay requirement, such that the slot n-n_{CSI_ref} is a valid downlink slot.

18. The BS of claim 17, wherein the CSI is obtained by measurement of a reference signal in slot n-n_{CSI_ref}.

19. The BS of claim 16, wherein a slot including at least one downlink symbol or flexible symbol and not included in a measurement gap for the UE is determined as the valid downlink slot.

20. The BS of claim 16,
wherein a slot including at least one SBFD symbol is determined as the valid downlink slot, and
wherein an active downlink BWP is not completely included within an uplink band and/or guard band in the SBFD symbol; or
wherein a slot including at least one SBFD symbol and not included in a measurement gap for the UE is determined as the valid downlink slot, and
wherein an active downlink BWP is not completely included within an uplink band and/or guard band in the SBFD symbol.
